(19) United States
(12) Patent Application Publication
(10) Pub. No.: US 2021/0289596 A1
(43) Pub. Date: Sep. 16, 2021

(54) Signalling Method for Dimmers Controlling a Load

(71) Applicant: Ozuno Holdings Limited, Road Town (VG)

(72) Inventors: James Vanderzon, MacDonald Park (AU); Andrew Newman, Stirling (AU)

(21) Appl. No.: 16/328,346

(22) PCT Filed: Aug. 25, 2017
(86) PCT No.: PCT/AU2017/050903

§ 371 Date: Feb. 26, 2019

(30) Foreign Application Priority Data
Aug. 26, 2016 (AU) 2016903409

(51) Int. Cl. H05B 45/10; H05B 45/32

(52) U.S. Cl. CPC H05B 45/10; H05B 45/32

(57) ABSTRACT

A signalling method for a plurality of dimmers controlling a load connected in series with an alternating current (AC) source, whereby each of the plurality of dimmers are connected in parallel with each other. The method includes: receiving a user control signal from an initiating one of the plurality of dimmers indicating a command for at least one of the plurality of dimmers; the initiating one of the plurality of dimmers generating one or more signalling pulses on a control waveform for at least one half cycle of the AC to the load based on the user control signal; each of the plurality of dimmers except the initiating one of the dimmers detecting the one or more signalling pulses for the at least one half cycle of the AC; and each of the plurality of dimmers except the initiating one of the dimmers determining the command based on the one or more signalling pulses for the at least one half cycle of the AC.

### TECHNICAL FIELD

The present invention relates to a signalling method for a plurality of dimmers controlling a load connected in series with an alternating current (AC) source. In particular, but not exclusively, the present invention relates to signalling for a dimming system including a plurality of multi-way dimmers for controlling a load such as a driver for an LED light source.

### BACKGROUND OF INVENTION

Dimmers typically include a dimmer circuit and a user interface (e.g. a rotary knob) to control power, in particular alternating current (AC) mains power, to a load, such as a light source. In one existing example of a dimmer, a light source can be dimmed using a phase controlled dimmer, whereby power provided to the load is controlled by varying the amount of time that a switch connecting the load to a mains power source is conducting during a cycle of the AC (e.g. varying the duty cycle). Specifically, in this example, AC power to the load is switched ON and OFF during each half cycle of alternating current and the amount of dimming of the load is provided by the amount of ON time in relation to the OFF time for each half cycle.

Phase control dimmer circuits generally operate as trailing edge or leading edge dimmer circuits, and the two circuits are suited to different applications. In leading edge circuits, power is switched OFF at the beginning of each half cycle. In trailing edge circuits, power is switched OFF later in each half cycle (e.g. towards the end of each half cycle). Leading edge dimmer circuits are generally better suited to controlling power to inductive loads, such as small fan motors and iron core low voltage lighting transformers. Trailing edge dimmer circuits, on the other hand, are generally better suited to controlling power to capacitive loads, such as drivers for Light Emitting Diode (LED) lights.

In some applications, a dimming system including more than one user interface for a dimmer is employed to control a load. For example, in a room with multiple entry ways, multiple user interfaces at each of the entry ways communicate with a central dimmer to control the load which is say an LED light source for the room. Existing examples of dimming systems with multiple inputs include variations of a dimming system with a central master dimmer controlling the light source and multiple slave dimmer inputs. More specifically, the central master dimmer is a phase control dimmer and the multiple slave dimmer inputs simply remotely control the central dimmer via some type of communication means and signalling protocol. In these existing examples, however, the central dimmer requires an additional input for the additional signalling between the slave dimmer inputs and the master dimmer. The additional input may be, for instance, a radio frequency (RF) input for transmitting/receiving RF dimmer control signals or an extra low voltage wire input for transmitting/receiving dimmer control signals over an extra low voltage bus control system.

### SUMMARY OF INVENTION

Accordingly, in one aspect of the present invention, there is provided a signalling method for a plurality of dimmers controlling a load connected in series with an alternating current (AC) source, whereby each of the plurality of dimmers are connected in parallel with each other, the method includes: receiving a user control signal from an initiating one of the plurality of dimmers indicating a command for at least one of the plurality of dimmers; the initiating one of the plurality of dimmers generating one or more signalling pulses on a control waveform for at least one half cycle of the AC to the load based on the user control signal; each of the plurality of dimmers except the initiating one of the dimmers detecting the one or more signalling pulses for the at least one half cycle of the AC; and each of the plurality of dimmers except the initiating one of the dimmers determining the command based on the one or more signalling pulses for the at least one half cycle of the AC.

Examples of commands for at least one of the plurality of dimmers include: setup selection; initiator dimmer pulse signalling; setup cancel; setup save and exit; set up mode dimmer; setup mode timer minute; setup mode timer hour; and setup mode switch. Further, it will be appreciated by those persons skilled in the art that any desired data can be encoded as commands for at least one of the plurality of dimmers using combinations of signalling pulses in the above signalling method.

For example, each of the plurality of dimmers except the initiating one of the dimmers receives the initiator pulse signalling command and then relinquishes control of the load to the initiating one of the dimmers to provide multi-way control of the load. Preferably, the dimmers are all either leading edge phase control dimmers or are all trailing edge phase control dimmers. More preferably, the dimmers are all 2-wire phase control trailing edge dimmers which control a driver for controlling power to Light Emitting Diode (LED) lights connected in series with the AC source. Further, the control waveform is a trailing edge phase control waveform.

In an embodiment, the method further includes the initiating one of the plurality of dimmers altering the conduction period of the control waveform for at least one half cycle of the AC to the load for the one or more signalling pulses based on the user control signal; each of the plurality of dimmers except the initiating one of the dimmers detecting a change in the conduction period for the at least one half cycle of the AC; and each of the plurality of dimmers except the initiating one of the dimmers determining the command based on the change in the conduction period for the at least one half cycle of the AC.

In an embodiment, the method further includes the initiating one of the dimmers increasing the conduction period of the control waveform by a designated period, such as 0.1 ms, to form one of the signalling pulses for each of the least one half cycle of the AC to the load. For example, the AC source is mains electricity in Australia which has a voltage of 240V and a frequency of 50 Hz. For example, the dimmers include a plurality of trailing edge phase control dimmers for controlling power to drivers for Light Emitting Diode (LED) lights. A half cycle of the AC is therefore 10 ms; the conduction period forms some part of the 10 ms and is increased by 0.1 ms for at least one half cycle of the AC.

In an embodiment, increasing the conduction period by the designated period includes advancing a start of the conduction period of a following half cycle of the AC to the load by advancing turn-ON of the load for the following half cycle. That is, for the designated period, the conduction angle of the following and subsequent half cycles of the AC is advanced such that commencement of each half cycle conduction period occurs prior to a zero-crossing of the AC line voltage by a predetermined measure, such as 1-3%, of the half cycle conduction period (e.g. 0.1-0.3 ms). In an alternative embodiment, the conduction angle of the half cycles of the AC is advanced but is oscillated over the designated period, such as 0.1 ms, to form two or more signalling pulses for each half cycle of the AC to the load.

In an embodiment, the method further includes the initiating one of the dimmers increasing the conduction period for a designated number of half cycles of the AC to the load based on the user control signal. With reference to the above examples of commands, the number of half cycles forming the signalling period for the setup selection command is 4 half cycles and 40 ms and the number of half cycles forming the signalling period for the initiator pulse signalling command is 8 half cycles and 80 ms. That is, for example, the initiating one of the dimmers increases the conduction period by 0.1 ms for 8 half cycles of the AC to the load based on the user control signal indicative of the initiator pulse signalling command. The method further includes detecting the change in the conduction period for the designated number of half cycles of the AC and determining the command based on the designated number of half cycles of the AC accordingly. Each of the plurality of dimmers except the initiating one of the dimmers can therefore determine, for instance, the initiator pulse signalling command based on the detection of the increased conduction periods of 0.1 ms for 8 half cycles of the AC, which is thus over a designated 80 ms signalling pulse period.

In the embodiment, the designated number of half cycles of the AC to the load includes consecutive half cycles. In another embodiment, however, the designated number of half cycles of the AC need not be consecutive half cycles and more data can be encoded using such a signalling method. In any case, the signalling method can transmit configuration data or other additional command types to the dimmers, and data or additional commands can be encoded within a signalling frame of the designated number of half cycles. For example, signalling commands that may be intended for the configuration of dimmers could employ substantially longer signalling frames in order to convey more information. Also, it will be appreciated by those persons skilled in the art that the signalling commands may be received by the dimmers in the load ON-state or the load OFF-state using the above signalling method.

The method further includes a number of techniques for detecting the change in the conduction period for the at least one half cycle of the AC indicative of the transmitted commands. In one embodiment, the method further includes detecting a zero-crossing of the AC to the load and tracking the conduction period of the load for each half cycle of the AC based on a duty cycle of the zero-crossing of the AC to the load. In this embodiment, detecting the change in the conduction period for the at least one half cycle of the AC is based on a change in the duty cycle of the zero-crossing of the AC to the load.

In another embodiment, the method further includes detecting a decrease in voltage at each of the plurality of dimmers except the initiating one of the dimmers indicative of the change in the conduction period for the at least one half cycle of the AC.

In yet another embodiment, the method further includes detecting a rate of change in voltage at each of the plurality of dimmers exceeding a threshold rate indicative of the change in the conduction period for the at least one half cycle of the AC. It will be appreciated by those persons skilled in the art that the AC source will having a rate of change in voltage corresponding to the AC over time being a sine wave. For example, where mains electricity in Australia which has a voltage of 240V and a frequency of 50 Hz, the instantaneous maximum rate of change in voltage is around 0.1V/μs, occurring around the zero-crossing of the sine wave. The threshold rate indicative of the change in the conduction period is therefore set at rate that would not occur during normal operation of say 1V/μs. The rate of change in voltage indicative of the change in the conduction period for each half cycle of the AC for a signalling pulse is much faster again, such as around 1V/μs.

Accordingly, with reference to the example, each of the dimmers can detect a command in the form of signalling pulses instigated by an initiator dimmer. The signalling between the initiator dimmer and the other dimmer(s) includes the initiator pulse signalling command for the non-initiating dimmers to at least temporarily revert to an OFF-state in order to permit establishment of a new load conduction angle by the initiating dimmer. Alternatively to temporarily reverting to the OFF-state, the non-initiating dimmers can remain in the ON-state but their conduction period settings must be temporarily set at a level below the previous load conduction angle—thereafter the non-initiating dimmers follow the new load conduction angle established by the initiator dimmer as described below. In a further alternative example, a command in the form of signalling pulses is again instigated by an initiating dimmer and received by each of the dimmers except the initiating dimmer. Here, however, the signalling between the initiating dimmer and the other dimmer(s) includes the initiator pulse signalling command for the non-initiating dimmers to instead revert to the OFF state indefinitely in order to permit establishment of a new load conduction angle by the initiating dimmer.

These embodiments of the signalling method, with respect to the LED load example, provide that the resulting change in effective load conduction angle does not produce a noticeable change in load brightness level owing to the relatively low instantaneous line voltage at the part of the half-cycle where the change in load conduction angle is made. It will be appreciated by those persons skilled in the art that only at very low brightness levels that are not typically utilised—where load conduction angle is small—would such a small change in timing of start of a half-cycle load conduction period, of say 0.1 ms, produce perceivable changes in LED brightness. Accordingly, the choice of amount of conduction angle advancement for the signalling pulse is based on a minimum level that will be easily detectable by other parallel dimmers and a maximum level that would begin to produce excessive LED brightness changes. Hence, the signalling pulse for the Australian environment is within 1-3% range of the half-cycle conduction period (i.e. 0.1 to 0.3 ms).

In another embodiment, the signalling method is for a plurality of leading edge phase control dimmers for controlling power to inductive loads, such as fans. In one embodiment, the signalling method would also involve increasing the half-cycle load conduction period or it could involve the slope of the half-cycle leading edge voltage control waveform being applied to the load being increased or decreased away from that in normal operation. Such changes in load voltage leading edge slope are then detectable by all the remaining leading edge dimmers by detecting the rate of change in voltage at each of the plurality of dimmers.

In another aspect of the present invention, there is provided a dimming system for controlling a load, the dimming system including: a plurality of dimmers connected in series with the load and an alternating current (AC) source, whereby each of the plurality of dimmers are connected in parallel with each other, wherein each of the plurality of dimmers has a user interface and a dimmer circuit for controlling AC to the load, and wherein the dimmer circuit includes: a controller configured to: receive a user control signal from the user interface indicating a command for at least one of the plurality of dimmers, wherein if the controller of an initiating one of the plurality of dimmers receives the user control signal, the controller of the initiating one of the dimmers generates one or more signalling pulses on a control waveform for at least one half cycle of the AC to the load based on the user control signal, the controller of each of the plurality of dimmers except the initiating one of the dimmers detects the one or more signalling pulses for the at least one half cycle of the AC and determines the command based on the one or more signalling pulses for the at least one half cycle of the AC.

In an embodiment, the controller of the initiating one of the dimmers alters a conduction period of the control waveform for the at least one half cycle of the AC to the load for the one or more signalling pulses based on the user control signal; and the controller of each of the plurality of dimmers except the initiating one of the dimmers detects the change in the conduction period for the at least one half cycle of the AC and determines the command based on the change in the conduction period for the at least one half cycle of the AC.

In another embodiment, the dimmer circuit includes a microprocessor implementing the controller. The controller can include at least one of a conduction angle control circuit configured to track the conduction angle and conduction period of the load, a timing control circuit configured to determine the conduction angle of the load, and a zero-crossing detection circuit configured to detect the zero-crossing of the AC to the load. It will be appreciated by those persons skilled in the art, however, that the dimmer circuit could have any combination of these circuits being implemented by a microprocessor or by analogue circuits. In any case, the controller, or a combination of these circuits, is configured to determine conduction periods indicative of the AC being conducted to the load and non-conduction periods indicative of the AC not being conducted to the load using the zero-crossing of the AC to the load. The controller can also be further configured to track the conduction angle of the load by detecting change in the conduction angle of the load based on the conduction periods and the non-conduction periods of the AC to the load. Also, the controller can be further configured to determine the conduction angle of the load to control turn-OFF at each half cycle of the AC source in addition to turn-ON.

In an embodiment, the timing control circuit further includes a switching circuit for controlling delivery of the AC to the load by conducting power to the load in the ON state and not conducting power to the load in the OFF state and a switching control circuit for controlling turn-OFF and turn-ON of the switching circuit at each cycle of the AC to control switching of the ON and OFF states of the switching circuit. Also, the dimming circuit further includes a rectifier for rectifying the AC in the non-conduction period to generate rectified dimmer voltage to be provided to the dimmer circuit.

In an embodiment, the controller of the initiating one of the dimmers increases the conduction period of the control waveform by a designated period (e.g. 0.1 ms) to form one of the signalling pulses for each of the least one half cycle of the AC to the load. Further, the controller increases the conduction period by the designated period by advancing a start of the conduction period of a following half cycle of the AC to the load by advancing turn-ON the load for the following half cycle.

In an embodiment, the controller of the initiating one of the dimmers increases the conduction period for a designated number of half cycles (e.g. 8 consecutive half cycles) of the AC to the load based on the user control signal.

In an embodiment, the controller of each of the plurality of dimmers except the initiating one of the dimmers detects the increase in the conduction period for the designated number of half cycles of the AC and determines the command based on the designated number of half cycles of the AC to the load.

As described with respect to the signalling method, there are a number of techniques for detecting the change in the conduction period for the at least one half cycle of the AC indicative of the transmitted commands. One embodiment includes the zero-crossing detection circuit being configured to detect a zero-crossing of the AC to the load and to track the conduction period of the load for each half cycle of the AC based on a duty cycle of the zero-crossing of the AC to the load. In this embodiment, the controller is further configured to detect the change in the conduction period for the at least one half cycle of the AC based on a change in the duty cycle of the zero-crossing of the AC to the load.

In another embodiment, the controller is further configured to detect a rate of change in voltage at each of the plurality of dimmers exceeding a threshold rate indicative of the change in the conduction period for the at least one half cycle of the AC. In the embodiment, the controller includes a signalling receiver circuit configured to detect the rate of change in voltage at each of the plurality of dimmers. Alternatively, the function of the signalling receiver circuit could be implemented by, for example, the above mentioned microprocessor.

In an example of the dimming system in use, the initiating dimmer receives input by a user via the user interface to reduce brightness of the LED lights. In this embodiment, the user control signal includes an initiator pulse signalling command and the controller of the initiating one of the plurality of dimmers alters the conduction period of the control waveform for 8 consecutive half cycles of the AC to the load based on this user control signal. That is, the initiating dimmer provides signalling pulses for 8 consecutive half cycles before the controller of the initiating one of the dimmers adopts a new conduction angle in response to the input to reduce brightness of the LED lights. The controller of the initiating one of the plurality of dimmers determines the new conduction angle of the load to be a decrease in conduction angle, and the controller of the initiating one of the dimmers provides the new conduction angle.

In the example, the controller of each of the plurality of dimmers except the initiating one of the dimmers detects a change in the conduction period for the 8 successive half cycles of the AC and determines the initiator pulse signalling command based on the change in the conduction period for the 8 half cycles of the AC based on one of the detection methods. The controller of each of the plurality of dimmers except the initiating one of the dimmers then relinquishes control to the initiating dimmer and awaits the new conduction angle. That is, the timing control circuit of each of the plurality of dimmers except the initiating one of the dimmers turns-OFF the AC switch until the conduction angle control circuit determines the new conduction angle caused by the initiating one of the dimmers based on the conduction periods and the non-conduction periods of the AC, and the timing control circuit of each of the plurality of dimmers except the initiating one of the dimmers adopts the new conduction angle for the respective AC switch indicative of the reduce brightness of the LED lights.

In another aspect of the present invention, there is provided a signalling method for a plurality of dimmers controlling a load connected in series with an alternating current (AC) source, whereby each of the plurality of dimmers are connected in parallel with each other, the method includes: receiving a user control signal from an initiating one of the plurality of dimmers indicating a command for at least one of the plurality of dimmers and the load; the initiating one of the plurality of dimmers generating one or more signalling pulses on a control waveform for at least one half cycle of the AC to the load based on the user control signal; the load detecting the one or more signalling pulses for the at least one half cycle of the AC; and the load determining the command based on the one or more signalling pulses for the at least one half cycle of the AC.

In yet another aspect of the present invention, there is provided a dimming system for controlling a load, the dimming system including: a plurality of dimmers connected in series with the load and an alternating current (AC) source, whereby each of the plurality of dimmers are connected in parallel with each other, wherein each of the plurality of dimmers has a user interface and a dimmer circuit for controlling AC to the load, and wherein the dimmer circuit includes: a controller configured to: receive a user control signal from the user interface indicating a command for at least one of the plurality of dimmers, wherein if the controller of an initiating one of the plurality of dimmers receives the user control signal, the controller of the initiating one of the dimmers generates one or more signalling pulses on a control waveform for at least one half cycle of the AC to the load based on the user control signal, a controller of the load detects the one or more signalling pulses for the at least one half cycle of the AC and determines the command based on the one or more signalling pulses for the at least one half cycle of the AC.

In an embodiment of this aspect, the initiating one of the plurality of dimmers again alters a conduction period of the control waveform for at least one half cycle of the AC to the load for the one or more signalling pulses based on the user control signal; and the load detects a change in the conduction period for the at least one half cycle of the AC and determines the command based on the change in the conduction period for the at least one half cycle of the AC. An example of a load command, where the load is LED lights, is for the LED lights to change colour.

It will also be appreciated by those persons skilled in the art that the load controller is implemented by a microprocessor, which can include similar modules to those described above to detect the signalling pulses and to determine the command. For example, the load controller can include a module to detect a rate of change in load voltage exceeding a threshold rate indicative of the change in the conduction period for the at least one half cycle of the AC.

### BRIEF DESCRIPTION OF DRAWINGS

Embodiments of the present invention will now be described, by way of example only, with reference to the accompanying drawings, in which:

FIG. 1 shows a dimming system for controlling a load according to an embodiment of the present invention;

FIG. 2A shows a block diagram of a dimmer of the dimming system of FIG. 1;

FIG. 2B shows a block diagram of a dimmer of the dimming system of FIG. 1;

FIG. 3 shows signals of a dimming system for controlling a load in an OFF state according to an embodiment of the present invention where the load is a resistive load;

FIG. 4 shows signals of a dimming system for controlling a load in an ON state according to an embodiment of the present invention where the load is a capacitive load;

FIG. 5 shows waveforms of an initiating one of the plurality of dimmers in the dimming system of FIG. 1;

FIG. 6 shows signalling pulses for designated half cycles of the AC indicative of commands according to an embodiment of the present invention;

FIG. 7 is a block diagram of a controller of a dimmer of a dimming system according to an embodiment of the present invention;

FIG. 8 is a circuit diagram of a zero-cross detector circuit of the controller of FIG. 7;

FIG. 9 is a circuit diagram of a signalling receiver circuit of the controller of FIG. 7; and

FIG. 10 is flow chart of a signalling method for a plurality of dimmers controlling a load according to an embodiment of the present invention.

### DETAILED DESCRIPTION

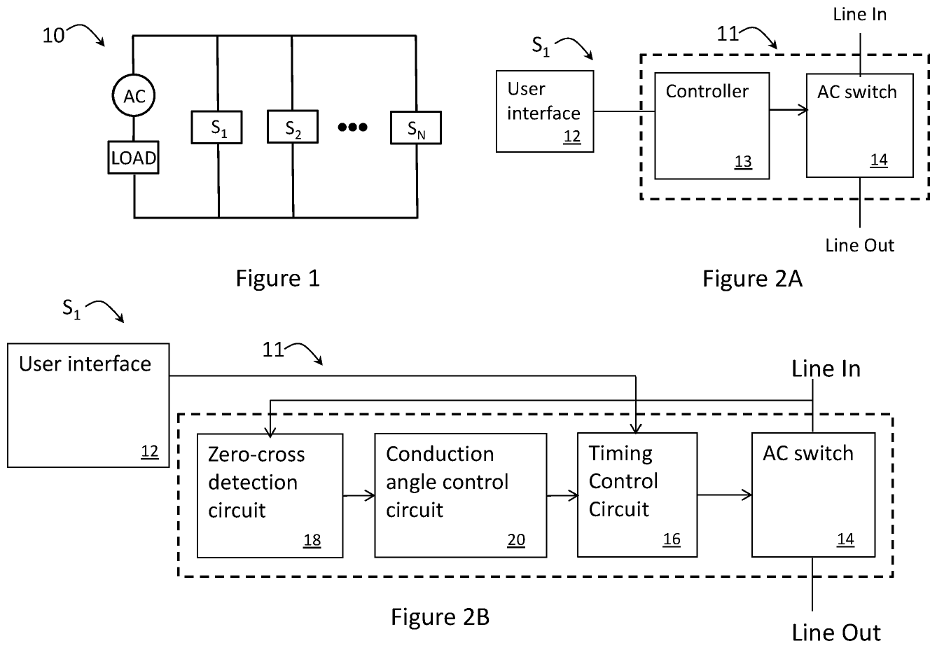

FIG. 1 shows an embodiment of a dimming system 10 for controlling a load having a plurality of dimmers S₁-S_{N}, whereby each of the plurality of dimmers S₁-S_{N} are connected in parallel with each other and the plurality of dimmers S₁-S_{N} are connected in series with the load and an alternating current (AC) source. As discussed, the load is preferably a driver for LED lights and the user controls brightness of the LED lights using each of the multi-way dimmers S₁-S_{N}. Also, the dimmers are preferably trailing edge phase control dimmers for controlling the LED lights.

FIG. 2A shows an embodiment of one of the dimmers S₁ in more detail, which has a dimmer circuit 11 for controlling alternating current (AC) to the load. The dimmer S₁ also has a user interface 12 for a user to control the brightness of the load and to input other commands. Further, it will be appreciated by those persons skilled in the art that the dimming system of FIG. 1 could be representative of a room with multiple entry ways and each of the dimmers S₁-S_{N} are multi-way dimmers that allow a user to control brightness of the LED lights in the room independently from each of the dimmers at the entry ways. The dimmer circuit 11 includes a controller 13 configured to perform a number of steps to implement control of the load by controlling an AC switch 14.

FIG. 2B shows a further embodiment of one of the dimmers S₁ in more detail, which has a dimmer circuit 11 for controlling alternating current (AC) to the load. The dimmer S₁ also has a user interface 12 for a user to input commands, such as controlling the brightness of the load or to enter setup modes. Preferably, the dimmers S₁-S_{N} are 2-wire trailing edge phase control dimmers for controlling brightness of a light source, such as a LED light source. It will be appreciated by those persons skilled in the art that N can be any number of dimmers wired in parallel, with N being limited by the light source load not illuminating due to the combined OFF state leakage current of the N dimmers. It will also be appreciated that the load can be an inductive, capacitive or resistive load. In one embodiment, for instance, the load is a driver for Light Emitting Diode (LED) lights and is a capacitive load. In another embodiment, the dimmers S₁-S_{N} are 2-wire leading edge phase control dimmers and the load is inductive. In yet another embodiment, the load is an incandescent lamp and is a resistive load; in this embodiment, either all leading or all trailing edge phase control dimmers are suitable.

In the embodiment of FIG. 2B, the dimmer circuit 11 includes a number of further circuits rather than the controller 13 to implement control of the load. It will be appreciated by those persons skilled in the art that many circuits of the dimmer circuit 11 do not affect operation of the multi-way dimming system and thus will not be discussed in detail herein. The circuits of the dimmer circuit 11 that affect operation include an AC switch 14 for switching the AC to the load at a conduction angle to control the load. The AC switch 14 applies line voltage to the load only during a selected conduction period within each polarity of AC voltage half-cycle. That is, the AC is conducted to the load in an ON state and not conducted to the load in an OFF state, and the ON state is a conduction period and the OFF state is a non-conduction period.

The dimmer control circuit 11 also includes a timing control circuit 16 configured to determine the conduction angle of load to control turn-OFF and turn-ON at each cycle of the AC to control switching of the ON and OFF states of the AC switch 14. The timing control circuit 16 determines the conduction angle of the load based on at least a user control signal from the user interface 12 indicating the conduction angle of the load. For example, the user interface 12 is a rotary knob of a dimmer connected to a rotary encoder. The rotary encoder provides the user control signal in response to the user rotating the knob of the dimmer to arrive at a desired brightness of the LED lights.

The user control signal from the user interface 12 also indicates a command for at least one of the dimmers S₁-S_{N}. As discussed, for instance, the user inputted a desired brightness of the LED lights via the user interface which provides a user control signal indicating the initiator pulse signalling command. This command signals to the controller of each of the plurality of dimmers except the initiating one of the dimmers to relinquish control to the initiating dimmer and await the new conduction angle. The rotary knob can also be depressed a designated number of times to provide other commands. For instance, the user wishing to transmit a set up command for the other dimmers depresses the knob once to providing the set up command. In another example, the user interface 12 is a press-switch or some other interface of a dimmer that is connected to an encoder. The encoder here also provides the user control signal in response to the user pressing or otherwise interacting with the user interface of the dimmer.

The dimmer circuit 11 further includes a zero-cross detection circuit 18 configured to detect a zero-crossing of the AC and a conduction angle control circuit 20. The zero-crossing of the AC is used by the conduction angle control circuit 20 to determine the conduction periods and the non-conduction periods of the AC. The zero-cross detection circuit 18 thus provide an instantaneous timing indication of line voltage zero-crossing in each AC voltage half-cycle. The conduction angle control circuit 20 is subsequently configured to track the conduction angle of the load by detecting a change in the conduction angle of the load based on the conduction periods and the non-conduction periods of the AC. The zero-crossing of the AC occurs when the AC line voltage equals zero between the two polarities of the half cycles. In the multi-way dimming system 10, for all non-initiator dimmers—whether in the ON-state or OFF-state—their respective zero-cross detection circuits 18 provide an indication of the prevailing conduction angle of a present initiator dimmer.

The dimmer circuit 11 also includes a rectifier (not shown) for rectifying the AC power in the non-conduction period to generate rectified dimmer voltage to be provided to the dimmer circuit 11. Also, the timing control circuit 16 of the dimmer circuit 11 has two circuits: a gate drive circuit (not shown) and a conduction period timing circuit (not shown). The gate drive circuit has a number of further circuits for controlling turn-OFF and turn-ON of the AC switch 14 at each half cycle of the AC to control switching of the load ON and OFF states. The rectifier and the gate drive and conduction period timing circuits may adopt various configurations known in the art without affecting the working of the dimming system 10 other than providing voltage to the dimmer circuit 11 and thus will not be further discussed.

It will be appreciated by those persons skilled in the art that the timing control circuit 16, as shown in FIG. 2B, includes switching elements, which are MOSFET switching devices. For example, the MOSFETs are high voltage (600V) N-channel MOSFETs (e.g. FCPF11N60), which are used to control the amount of power delivered to the load. Two of these MOSFETs are configured so that they alternately control power delivery to the load over the different polarity half cycles of AC power. That is, each of the MOSFETs turn-ON and turn-OFF the switching circuit 12 at each cycle of the AC, respectively, so that the load (e.g. a driver for LED down lights) is dimmed in proportion to the amount of time in each cycle that the AC switch 14 is switched OFF.

In use of the system 10, if the initiating one of the plurality of dimmers S₁ receives a user control signal from the user interface 12 indicating for example an increase in brightness, the user control signal thus also includes an initiator pulse signalling command for the remaining dimmers S₂-S_{N} in the system 10. The controller 13 of the initiating one of the dimmers S₁ communicates the signal by generating signalling pulses on a control waveform for half cycles of the AC to the LED lights based on the user control signal. More specifically, the timing control circuit 16 increases a conduction period of the control waveform by a designated period of 0.1 ms to form a signalling pulse for the next half cycle and for 7 more successive half cycles of the AC to the load (i.e. for 80 ms) based on this user control signal. The timing control circuit 16 of the initiating one of the dimmers S₁ increases the conduction period for 8 consecutive half cycles of the AC to the load by modifying turn-ON of the load for these 8 half cycles of the AC to the load. Modifying the turn-ON, in this embodiment, involves the timing control circuit 16 advancing a start of the conduction period for each half cycle of the AC to the load by advancing turn-ON of the load by the designated period of 0.1 ms to form the signalling pulse.

The controller 13 of each of the dimmers S₂-S_{N} detects the 8 signalling pulses as advances in the conduction period for 0.1 ms for 8 half cycles of the AC and determines the command based on these signalling pulses. As described, the controller 13 detects the increase in the conduction period for 8 half cycles of the AC and determines the command based on the 8 half cycles of the AC—in this case, an initiator pulse signalling command.

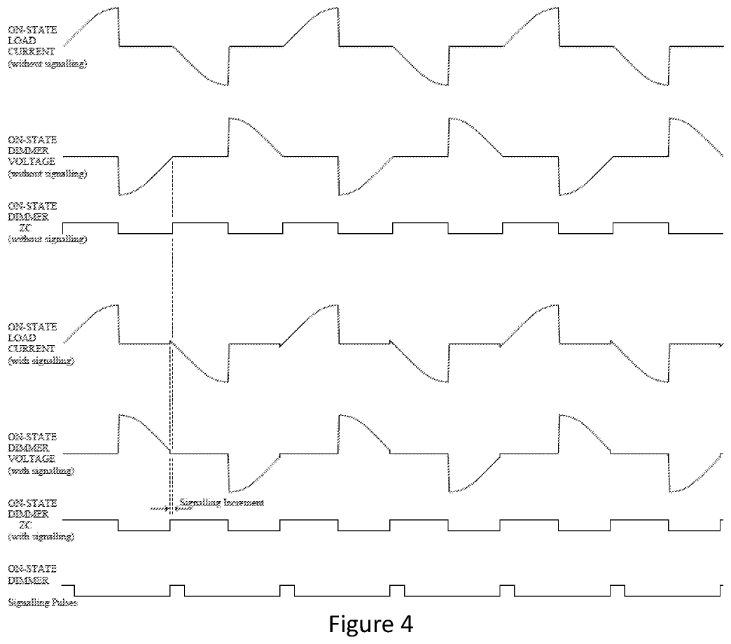

FIG. 4 show signals of the dimming system 10 for controlling a load where the load is in the ON state. Here, it can be seen that the timing control circuit 16 of the initiating one of the dimmers S₁ generates signalling pulses on the control waveform for half cycles of the AC to the load. The conduction periods of the control waveform are increased by 0.1 ms—as shown on the ON-state Load Current with signalling waveform—to form signalling pulses for 6 consecutive half cycles based on this user control signal. As described, the timing control circuit 16 of the initiating one of the dimmers S₁ increases these conduction periods by advancing a start of the conduction period for the half cycles of the AC to the load by the signalling increment of 0.1 ms.

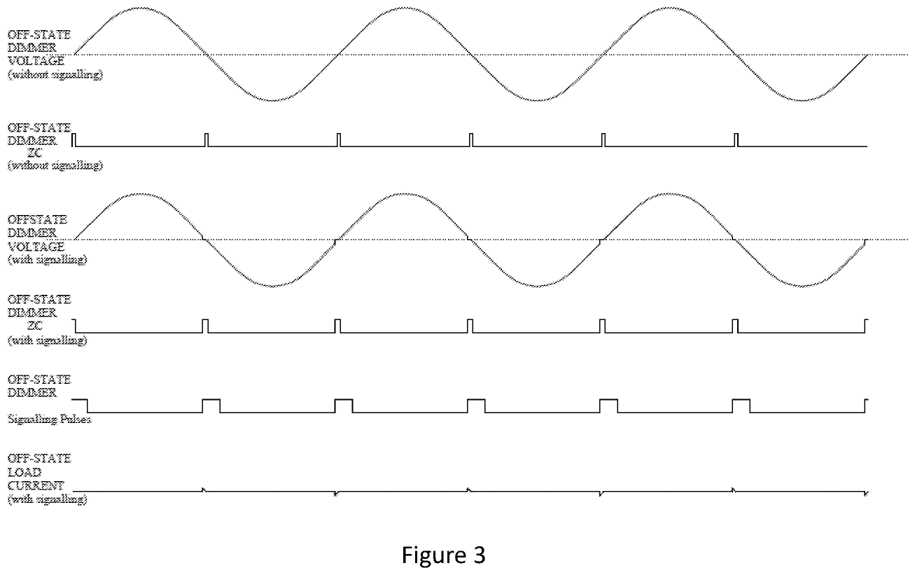

FIG. 3 show signals of the dimming system 10 for controlling a load where the load is in the OFF state. Specifically, FIGS. 3 and 4 illustrate example control waveforms associated with the dimming system 10 where the dimmers are trailing edge phase control multi-way dimmers. When the load is in the OFF state, as shown in FIG. 3, the controller 13 of the initiating one of the dimmers S₁ can still generate signalling pulses on a control waveform for half cycles of the AC to the load based on the received user control signal. Here, the timing control circuit 16 turns-ON the load at very low conduction angles at the zero-crossings of the AC to the load by the designated period of 0.1 ms to form the signalling pulses for the next half cycle and for successive half cycles of the AC to the load based on this user control signal. The 0.1 ms signalling pulses are not able to be visually detected when used with respect to LED lights and thus the dimming system 10 can be controlled while the LED lights are OFF using this method.

In one embodiment, the controller 13 detects the signalling pulses that are advances in the conduction period with the zero-cross detection circuits 18 of the dimmers S₂-S_{N}, which detect a change in the zero-crossing of the AC in response to the new conduction periods. The zero-cross detection circuits 18 track the conduction periods of the load for each half cycle of the AC based on a duty cycle of the zero-crossing of the AC to the load, and detect the change in the conduction period for the half cycles of the AC based on a change in the duty cycle of the zero-crossing of the AC to the load.

In addition, zero-cross detection circuits 18 can track the conduction periods of the load for each half cycle of the AC to adopt a new conduction angle for the load. For example, upon determination of the initiator pulse command by the zero-cross detection circuits 18 detecting 8 consecutive signalling pulses, each of the plurality of dimmers S₂-S_{N} except the initiating dimmer S₁ turns-OFF AC to the AC switch 14 and relinquishes control to the initiating dimmer S₁ so that a new conduction angle of the load can be established and later followed by the each of the plurality of dimmers S₂-S_{N}. That is, in this example, timing control circuit 16 of the initiating dimmer S₁ determines a new conduction angle of the load based on the user control signal to increase brightness and the timing control circuit 16 of the dimmer S₁ uses the new conduction angle which subsequently affects the zero-crossing of the AC for the load. The zero-cross detection circuit 18 of each of the plurality of dimmers S₂-S_{N} except the initiating dimmer S₁ detects a change in the duty cycle of the zero-crossing of the AC in response to the new conduction angle. The corresponding conduction angle control circuit 20 of the dimmers S₂-S_{N} tracks this new conduction angle by detecting the change in the conduction angle of the load and the timing control circuit 16 of each the dimmers S₂-S_{N} adopts the new, desired conduction angle.

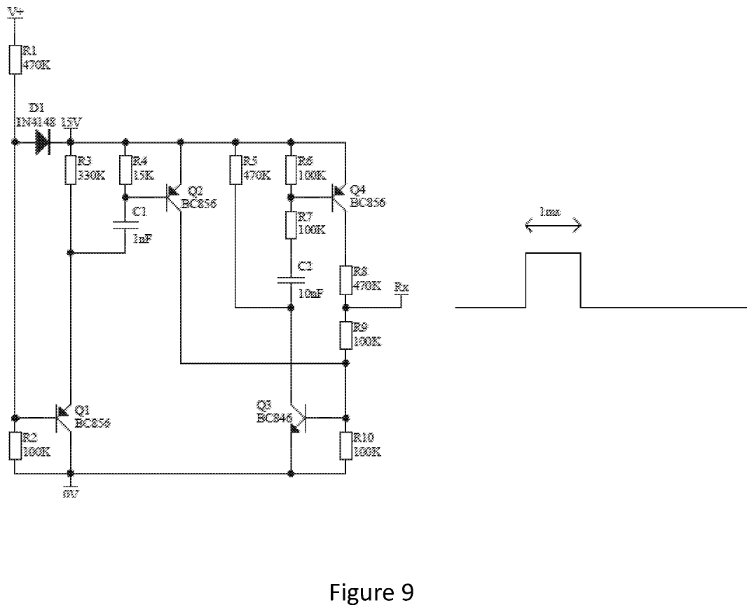

In another embodiment, the controller 13 detects the signalling pulses that are advances in the conduction period by detecting a rate of change in voltage at each of the dimmers S₂-S_{N} exceeding a threshold rate indicative of the change in the conduction period for the at least one half cycle of the AC. The controller 13 includes a signalling receiver circuit shown in FIG. 9 to detect the rate of change in voltage exceeding a threshold rate of say 1V/μs.

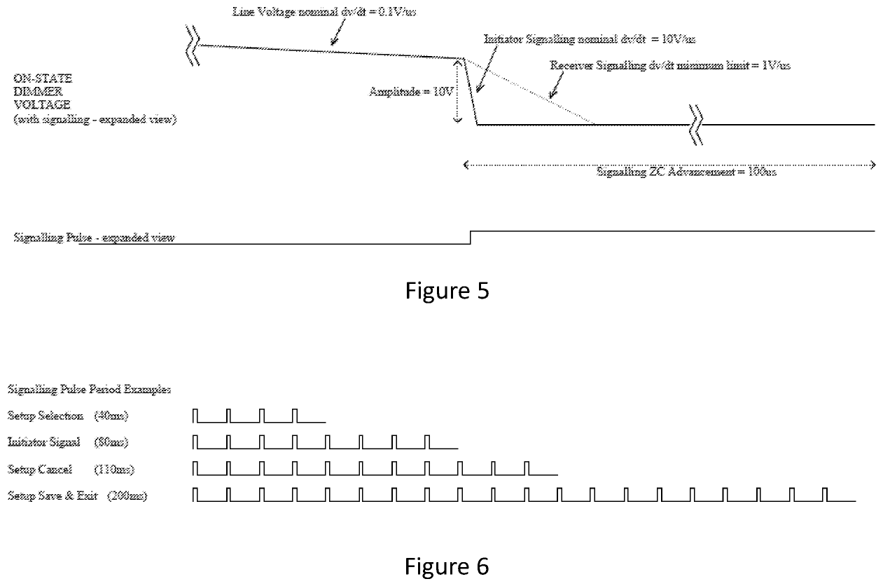

FIG. 5 shows the change in voltage across one of the dimmers S₁-S_{N} during a signalling pulse, where the normal, relatively slow, rate of change of voltage at about 0.1V/μs is substantially increased by a factor of up to 100 to about 10V/μs. In comparison to normal line voltage, the signalling receiver circuit can detect signalling pulses where the timing of the zero-cross detection is advanced by at least 100 μs. To allow for the filtering effects of capacitance associated with some lighting load types, the signalling receiver is responsive to zero-crossing dimmer voltage dv/dt as slow as 1V/μs. Hence, as above, the threshold rate is set at 1V/μs.

To generate a signalling pulse, the timing output of the zero-cross detection circuit 18 advances the zero-crossing of the next half cycle and for a designated number of following half cycles of the AC to the load by about 100 μs. This corresponds to a very fast decrease in dimmer voltage at each of the dimmers S₁-S_{N} from around 10V (to 0V), of around at least 1V/μs, but up to 101V/μs, which is detectable by the above mentioned signalling receiver circuits of the dimmers S₂-S_{N}. The respective controllers 13 of the dimmers S₂-S_{N} detect the increase in the conduction period in this way for the designated number of half cycles of the AC and thus can determine the command based on the detected designated number of half cycles of the AC.

FIG. 6 shows an example of different commands and their corresponding signalling pulses. For example, the set up selection command is selected by a user by say pressing once on the user interface 12 and has a designated signalling period of 40 ms consisting of four 0.1 ms signalling pulses over consecutive half cycles. Other commands are detailed in the table below

| | Period of | |
|---|---|---|
| Command | Signalling | Purpose |
| Setup Selection | 40 ms | Determine which feature is being |
| | | changed in Setup Mode. |
| | | 1 signalling period = 1 user click |
| | | during Setup Selection Mode |
| | | (feature selection). |
| Initiator Pulse | 80 ms | Used during Normal and Setup |
| signalling | | Mode to signal all other dimmers |
| | | to Turn Off and Follow. This is the |
| | | primary signalling mechanism. |
| spare | 110 ms | not currently used |
| Setup Cancel | 150 ms | Cancel Setup Mode |
| Setup Save and Exit | 200 ms | Save any changed settings and |
| | | Exit Setup Mode |
| Setup Mode Dimmer | 250 ms | All Dimmers enter Setup Mode |
| Setup Mode Timer | 300 ms | All Minute Timers enter |
| Minute | | Setup Mode |
| Setup Mode Timer | 350 ms | All Hour Timers enter |
| Hour | | Setup Mode |
| Setup Mode Switch | 400 ms | All Switch products enter |
| | | Setup Mode |

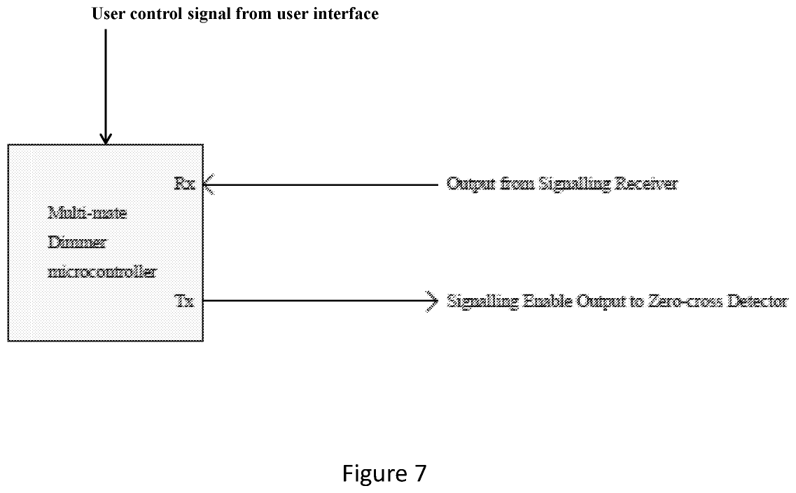

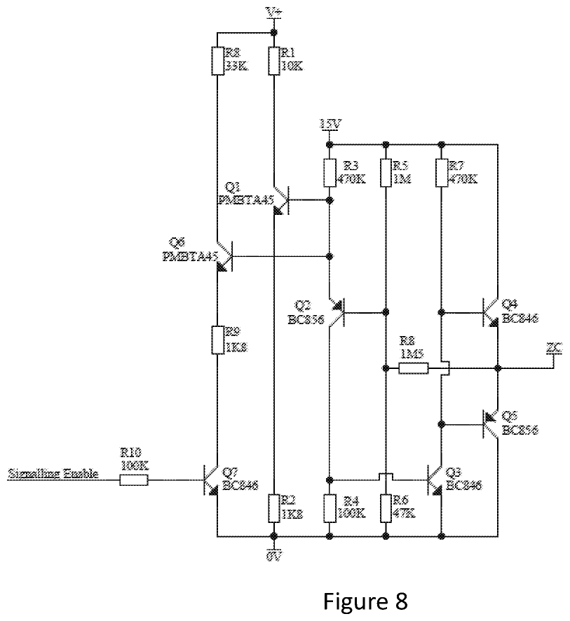

FIG. 7 shows an embodiment of a controller of the dimmers S₁-S_{N} in the dimmer system 10 in the form of a microprocessor implementing at least part of the dimmer circuit 11. That is, in this embodiment, each of the dimmers S₁-S_{N} have a user interface 12, such as a knob that is cable of being pressed and is connected to a rotary encoder for generating the user command signals, to permit input of commands and adjustment of load conduction angle. The microcontroller also outputs to a zero cross detection circuit shown in FIG. 8 and receives input from the signalling receiver circuit shown in FIG. 9 described above.

In more examples of the system 10 in use, it will be appreciated that the load can be initially either in the ON or OFF state. If the load is in the OFF state, any of the dimmers S₁-S_{N} can be the initiating dimmer S₁ by the user rotating or pressing the knob so that the corresponding initiating dimmer S₁ generate the signalling pulses to the other dimmers S₂-S_{N}. In the example where the non-initiating dimmers S₂-S_{N} stay in the OFF state indefinitely, these signalling pulses are redundant. Also, in the example where the non-initiating dimmers stay in the OFF state indefinitely and the load is in the ON state, the initiating dimmer S₁ is the only dimmer in the system 10 in the ON state. The user, however, can control the load from any one of the other dimmers S₂-S_{N} by rotating or pressing the knob of a dimmer to turn that dimmer into the ON state. The new initiating dimmer S_{1′} then generates the signalling pulses to the other dimmers including the old initiating dimmer S₁ to revert to the OFF-state so that the new initiating dimmer S_{1′} can control the load to control the brightness by rotating the knob and to turn the load OFF by depressing the knob.

FIG. 8 shows an embodiment of a zero-cross detection circuit described above that used to advance the half-cycle conduction period for signalling purposes and can also be used for detection purposes. During normal zero-cross detection without signalling pulses, the signalling enable input is low; therefore transistor Q7 is not driven and consequently transistor Q6 has no conduction. Transistor Q1 is however permanently biased and enabled to conduct collector current at about 0.3 mA through resistor R1 and emitter resistor R2. The base bias current for Q1 is provided by resistor R3, where bias voltage is determined by transistor Q2 in conjunction with resistive voltage divider R5 and R6. At non-zero (rectified) dimmer voltage, collector current remains available to transistor Q1 and therefore Q1 base terminal does not significantly load the emitter voltage of transistor Q2. Transistor Q2 therefore remains in conduction state and drives transistor Q3, which in turn acts to pull low the output buffer stage comprising transistors Q4 and Q5, so that zero-crossing signal output is low. When the signalling enable indicating a signalling pulse to Q7 is set high, this enables additional transistor Q6 to conduct, provided that the rectified dimmer voltage exceeds about 10V. The timing output of zero-cross detector therefore advances by about 100 μs—corresponding to dimmer voltage of about 10V—so that commencement of the dimmer half-cycle conduction period is advanced accordingly.

FIG. 9 shows the signalling receiver circuit used to detect signalling pulses as described. The rectified dimmer voltage is applied to a resistive voltage divider comprising R1 and R2, having divider ratio of about 0.17, so that a 10V amplitude signalling transition appears as a 1.7V transition at base terminal of receiver transistor Q1. A Diode D1 is used to clamp the maximum voltage at output of voltage divider. The receiver transistor Q1 is configured as an emitter follower with emitter resistor R3; therefore the received voltage transition also appears at Q1 emitter. A differentiator circuit comprising R4 and Cl is used to couple the received voltage transition to base terminal of pnp transistor Q2 which functions as a voltage comparator circuit. The capacitance value of Cl and resistance value of R4 are selected such that Q2 is driven into conduction state if the signalling voltage transition dv/dt is at least the threshold rate of 1V/us. The output from Q2 is used to trigger a monostable pulse generator comprising Q3, Q4 and associated components, to generate a nominal 0.1 ms pulse to signify the presence of the signalling pulse.

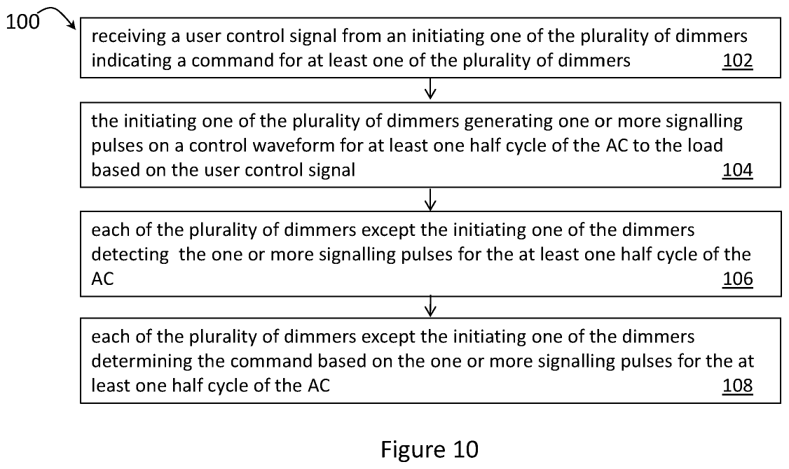

Referring now to FIG. 10, there is shown a summary of a signalling method 100 for a plurality of dimmers controlling a load connected in series with an alternating current (AC) source, whereby each of the plurality of dimmers are connected in parallel with each other. The method 100 includes: receiving 102 a user control signal from an initiating one of the plurality of dimmers indicating a command for at least one of the plurality of dimmers; the initiating one of the plurality of dimmers generating 104 one or more signalling pulses on a control waveform for at least one half cycle of the AC to the load based on the user control signal; each of the plurality of dimmers except the initiating one of the dimmers detecting 106 the one or more signalling pulses for the at least one half cycle of the AC; and each of the plurality of dimmers except the initiating one of the dimmers determining 108 the command based on the one or more signalling pulses for the at least one half cycle of the AC.

Further aspects of the method will be apparent from the above description of the dimming system 10. A person skilled in the art will also appreciate that at least parts of the method 100 could be embodied in program code for implementation on the above mentioned microprocessor. The program code could be supplied in a number of ways, such as on a memory of the dimmer circuit 11 in data communication with the microprocessor, and could be configured to be implemented by the microprocessor implementing at least part of the dimmer circuit 11.

It will be understood that there may be other variations and modifications to the configurations described herein that are also within the scope of the present invention.

The discussion of documents, acts, materials, devices, articles and the like is included in this specification solely for the purpose of providing context for the present invention. It is not suggested or represented that any of these matters formed part of the prior art base or were common general knowledge as it existed before the priority date of each claim of this application.

1. A signalling method for a plurality of dimmers controlling a load connected in series with an alternating current (AC) source, whereby each of the plurality of dimmers are connected in parallel with each other, the method includes:
receiving a user control signal from an initiating one of the plurality of dimmers indicating a command for at least one of the plurality of dimmers;
the initiating one of the plurality of dimmers generating one or more signalling pulses on a control waveform for at least one half cycle of the AC to the load based on the user control signal;
each of the plurality of dimmers except the initiating one of the dimmers detecting the one or more signalling pulses for the at least one half cycle of the AC; and
each of the plurality of dimmers except the initiating one of the dimmers determining the command based on the one or more signalling pulses for the at least one half cycle of the AC.

2. The signalling method according to claim 1, further including:
the initiating one of the plurality of dimmers altering a conduction period of the control waveform for said at least one half cycle of the AC to the load for the one or more signalling pulses based on the user control signal;
each of the plurality of dimmers except the initiating one of the dimmers detecting a change in the conduction period for the at least one half cycle of the AC; and
each of the plurality of dimmers except the initiating one of the dimmers determining the command based on the change in the conduction period for the at least one half cycle of the AC.

3. The signalling method according to claim 2, further including the initiating one of the dimmers increasing the conduction period of the control waveform by a designated period to form one of the signalling pulses for each of the least one half cycle of the AC to the load.

4. The signalling method according to claim 3, wherein increasing the conduction period by the designated period includes advancing a start of the conduction period of a following half cycle of the AC to the load by advancing turn-ON of the load for the following half cycle.

5. The signalling method according to claim 3, further including the initiating one of the dimmers increasing the conduction period for a designated number of half cycles of the AC to the load based on the user control signal.

6. The signalling method according to claim 5, further including detecting the increase in the conduction period for the designated number of half cycles of the AC and determining the command based on the designated number of half cycles of the AC to the load.

7. The signalling method according to claim 6, wherein the designated number of half cycles of the AC to the load includes consecutive half cycles of the AC.

8. The signalling method according to claim 2, further including detecting a zero-crossing of the AC to the load and tracking the conduction period of the load for each half cycle of the AC based on a duty cycle of the zero-crossing of the AC to the load.

9. The signalling method according to claim 8, further including detecting the change in the conduction period for the at least one half cycle of the AC based on a change in the duty cycle of the zero-crossing of the AC to the load.

10. The signalling method according to claim 2, further including detecting a rate of change in voltage at each of the plurality of dimmers exceeding a threshold rate indicative of the change in the conduction period for the at least one half cycle of the AC.

11. A dimming system for controlling a load, the dimming system including:
a plurality of dimmers connected in series with the load and an alternating current (AC) source, whereby each of the plurality of dimmers are connected in parallel with each other, wherein each of the plurality of dimmers has a user interface and a dimmer circuit for controlling AC to the load, and wherein
the dimmer circuit includes:
a controller configured to:
receive a user control signal from the user interface indicating a command for at least one of the plurality of dimmers,
wherein if the controller of an initiating one of the plurality of dimmers receives the user control signal, the controller of the initiating one of the dimmers generates one or more signalling pulses on a control waveform for at least one half cycle of the AC to the load based on the user control signal,
the controller of each of the plurality of dimmers except the initiating one of the dimmers detects the one or more signalling pulses for the at least one half cycle of the AC and determines the command based on the one or more signalling pulses for the at least one half cycle of the AC.

12. The dimming system according to claim 11, wherein the controller of the initiating one of the dimmers alters a conduction period of the control waveform for the at least one half cycle of the AC to the load for the one or more signalling pulses based on the user control signal; and
the controller of each of the plurality of dimmers except the initiating one of the dimmers detects the change in the conduction period for the at least one half cycle of the AC and determines the command based on the change in the conduction period for the at least one half cycle of the AC.

13. The dimming system according to claim 12, wherein the controller of the initiating one of the dimmers increases the conduction period of the control waveform by a designated period to form one of the signalling pulses for each of the least one half cycle of the AC to the load.

14. The dimming system according to claim 13, wherein increasing the conduction period by the designated period includes advancing a start of the conduction period of a following half cycle of the AC to the load by the controller advancing turn-ON of the load for the following half cycle.

15. The dimming system according to claim 13, wherein the controller of the initiating one of the dimmers increases the conduction period for a designated number of half cycles of the AC to the load based on the user control signal.

16. The dimming system according to claim 15, wherein the controller of each of the plurality of dimmers except the initiating one of the dimmers detects the increase in the conduction period for the designated number of half cycles of the AC and determines the command based on the designated number of half cycles of the AC.

17. The dimming system according to claim 16, wherein the designated number of half cycles of the AC to the load include consecutive half cycles of the AC.

18. The dimming system according to claim 12, wherein the controller is further configured to detect a zero-crossing of the AC to the load and to track the conduction period of the load for each half cycle of the AC based on a duty cycle of the zero-crossing of the AC to the load.

19. The dimming system according to claim 18, wherein the controller is further configured to detect the change in the conduction period for the at least one half cycle of the AC based on a change in the duty cycle of the zero-crossing of the AC to the load.

20. The dimming system according to claim 12, wherein the controller is further configured to detect a rate of change in voltage at each of the plurality of dimmers exceeding a threshold rate indicative of the change in the conduction period for the at least one half cycle of the AC.

21. The dimming system according to claim 20, wherein the controller includes a signalling receiver circuit configured to detect the rate of change in voltage at each of the plurality of dimmers.

22. A signalling method for a plurality of dimmers controlling a load connected in series with an alternating current (AC) source, whereby each of the plurality of dimmers are connected in parallel with each other, the method includes:
receiving a user control signal from an initiating one of the plurality of dimmers indicating a command for at least one of the plurality of dimmers and the load;
the initiating one of the plurality of dimmers generating one or more signalling pulses on a control waveform for at least one half cycle of the AC to the load based on the user control signal;
the load detecting the one or more signalling pulses for the at least one half cycle of the AC; and
the load determining the command based on the one or more signalling pulses for the at least one half cycle of the AC.

23. A dimming system for controlling a load, the dimming system including:
a plurality of dimmers connected in series with the load and an alternating current (AC) source, whereby each of the plurality of dimmers are connected in parallel with each other, wherein each of the plurality of dimmers has a user interface and a dimmer circuit for controlling AC to the load, and wherein
the dimmer circuit includes:
a controller configured to:
receive a user control signal from the user interface indicating a command for at least one of the plurality of dimmers,
wherein if the controller of an initiating one of the plurality of dimmers receives the user control signal, the controller of the initiating one of the dimmers generates one or more signalling pulses on a control waveform for at least one half cycle of the AC to the load based on the user control signal,
a controller of the load detects the one or more signalling pulses for the at least one half cycle of the AC and determines the command based on the one or more signalling pulses for the at least one half cycle of the AC.
